(19) United States
(12) Patent Application Publication
(10) Pub. No.: US 2026/0253583 A1
(43) Pub. Date: Aug. 27, 2026

(54) SPEECH RECOGNITION APPARATUS, SPEECH RECOGNITION METHOD, AND PROGRAM

(71) Applicant: NEC Corporation, Minato-ku, Tokyo (JP)

(72) Inventors: Kenkoh ENDOH, Tokyo (JP); Hitoshi YAMAMOTO, Tokyo (JP); Koji OKABE, Tokyo (JP); Ling GUO, Tokyo (JP)

(73) Assignee: NEC Corporation, Minato-ku, Tokyo (JP)

(21) Appl. No.: 18/874,630

(22) PCT Filed: Jun. 30, 2023
(86) PCT No.: PCT/JP2023/024504

§ 371 Date: Dec. 13, 2024

(30) Foreign Application Priority Data
Jul. 14, 2022 (JP) 2022-112878

(51) Int. Cl. G10L 15/22; G10L 15/02; G10L 25/63

(52) U.S. Cl. CPC G10L 15/22; G10L 15/02; G10L 25/63; G10L 2015/227

(57) ABSTRACT

A speech recognition apparatus of the present disclosure includes: a transforming unit that transforms an utterance by an utterer into a feature vector; a weighting unit that weights the feature vector with importance of the utterance based on situation information representing a situation at time of the utterance by the utterer; and a recognizing unit that recognizes a new utterance by the utterer based on the weighted feature vector.

### TECHNICAL FIELD

The present invention relates to a speech recognition apparatus, a speech recognition method, and a program

### BACKGROUND ART

A speech recognizer is a device that outputs, from an input speech, a character string corresponding to the speech. There is a type of speech recognizer which includes a feature value encoder and a character string decoder. A feature value encoder uses speech as input and transforms it into a speech feature value. A character string decoder uses the speech feature value and so forth as input, and outputs a character string.

An example of a speech recognition technique is disclosed in Patent Literature 1. In Patent Literature 1, an utterance section detecting unit detects an utterance section, and extracts an utterance section feature value vector Xk, which is a feature value of the utterance section. Furthermore, a speech recognizing unit executes speech recognition based on the utterance section feature vector Xk.

On the other hand, the recognition rate of speech may decrease due to a situation at the time of utterance, such as the emotion and fatigue of an utterer. Therefore, in Patent Literature 2, a method using a biomonitor is proposed as a method for correcting a pitch change due to emotion and so forth. To be specific, in Patent Literature 2, a biosignal output from the biomonitor indicating a change in emotional state is used to compensate for the pitch change of a speech signal, and the decrease of the speech recognition rate is thereby suppressed. Moreover, in Patent Literature 3, the decrease of the speech recognition rate is suppressed by estimating the emotion of an utterer from video and using a speech recognizer individually adjusted for each emotion. Thus, in Patent Literatures 2 and 3, the decrease of the speech recognition rate caused by the change in pitch and speed of speech is suppressed by estimating the emotion of an utterer at the time of utterance.

### CITATION LIST

### Patent Literature

Patent Literature 1: WO 2022/049613
Patent Literature 2: JP 07-199986A
Patent Literature 3: JP 2020-181022A

### SUMMARY OF INVENTION

### Technical Problem

However, in Patent Literatures 2 and 3 described above, speech recognition is performed on speech at the time of utterance, so that there arises a problem that it cannot deal with a decrease of a speech recognition rate with topic and context being considered, such as recognition of homonyms that should change in accordance with topics at the time of utterances. As a concrete example of the above problem, in the case of an utterance, ‘Our company will “sozo” a better future’, candidates for the kanji of “sozo” are the kanji of “imagine” and the kanji of “create”, and either one will be used in accordance with the context. However, there is a case where an appropriate kanji is not selected and the speech recognition rate thereby decreases.

Accordingly, an object of the present invention is to provide a speech recognition apparatus that can solve the abovementioned problem, that is, decrease of the speech recognition rate.

### Solution to Problem

A speech recognition apparatus as an aspect of the present disclosure includes: a transforming unit that transforms an utterance by an utterer into a feature vector; a weighting unit that weights the feature vector with importance of the utterance based on situation information representing a situation at time of the utterance by the utterer; and a recognizing unit that recognizes a new utterance by the utterer based on the weighted feature vector.

Further, a speech recognition method as an aspect of the present disclosure includes: transforming an utterance by an utterer into a feature vector; weighting the feature vector with importance of the utterance based on situation information representing a situation at time of the utterance by the utterer; and recognizing a new utterance by the utterer based on the weighted feature vector.

Further, a program as an aspect of the present disclosure includes instructions for causing a computer to execute processes to: transform an utterance by an utterer into a feature vector;

weight the feature vector with importance of the utterance based on situation information representing a situation at time of the utterance by the utterer; and recognize a new utterance by the utterer based on the weighted feature vector.

### Advantageous Effects of Invention

Configured as described above, the present disclosure enables increase of the speech recognition rate.

### BRIEF DESCRIPTION OF DRAWINGS

FIG. 1 is a block diagram showing the overall configuration of a speech recognition apparatus in a first example embodiment of the present disclosure.

FIG. 2 is a block diagram showing part of the configuration of the speech recognition apparatus disclosed in FIG. 1.

FIG. 3 is a block diagram showing part of the configuration of the speech recognition apparatus disclosed in FIG. 1.

FIG. 4 is a flowchart showing the operation of the speech recognition apparatus disclosed in FIG. 1.

FIG. 5 is a block diagram showing part of the configuration of a speech recognition apparatus in a second example embodiment of the present disclosure.

FIG. 6 is a flowchart showing the operation of the speech recognition apparatus disclosed in FIG. 5.

FIG. 7 is a block diagram showing part of the configuration of a speech recognition apparatus in a third example embodiment of the present disclosure.

FIG. 8 is a block diagram showing the hardware configuration of a speech recognition apparatus in a fourth example embodiment of the present disclosure.

FIG. 9 is a block diagram showing the configuration of the speech recognition apparatus in the fourth example embodiment of the present disclosure.

### DESCRIPTION OF EXAMPLE EMBODIMENTS

### First Example Embodiment

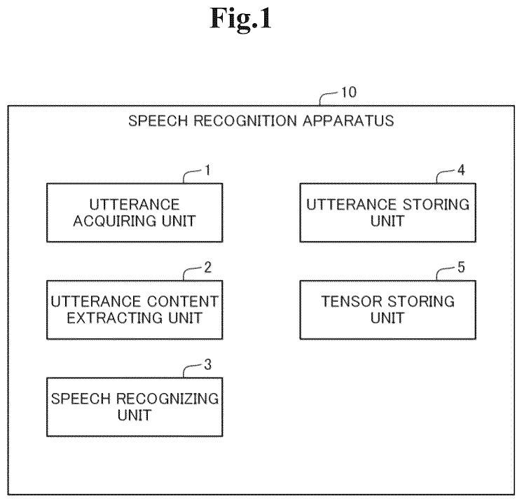

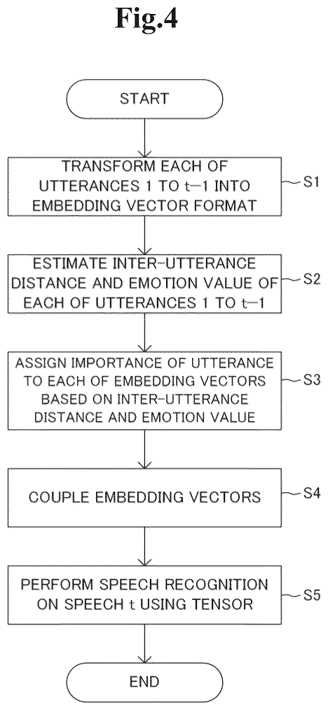

A first example embodiment of the present disclosure will be described with reference to FIGS. 1 to 4. FIGS. 1 to 3 are diagrams for describing the configuration of a speech recognition apparatus, and FIG. 4 is a diagram for describing the processing operation of the speech recognition apparatus.

### [Configuration]

A speech recognition apparatus 10 in this example embodiment is an apparatus that recognizes, from the speech of an utterance by an utterer, a character string corresponding to the speech. In particular, the speech recognition apparatus 10 in this example embodiment transforms speech into a feature value, recognizes a character string from the feature value, and outputs the character string.

The speech recognition apparatus 10 is configured with one or a plurality of information processing apparatuses each including an arithmetic logic unit and a memory unit. Then, as shown in FIG. 1, the speech recognition apparatus 10 includes an utterance acquiring unit 1, an utterance content extracting unit 2, and a speech recognizing unit 3. The respective functions of the utterance acquiring unit 1, the utterance content extracting unit 2, and the speech recognizing unit 3 can be realized by the arithmetic logic unit executing a program for realizing the respective functions stored in the memory unit. Moreover, the speech recognition apparatus 10 includes an utterance storing unit 4 and a tensor storing unit 5. The utterance storing unit 4 and the tensor storing unit 5 are configured by the memory unit. The respective components will be described in detail below.

The utterance acquiring unit 1 acquires utterances by an utterer and temporarily stores into the utterance storing unit 4. At this time, the utterance acquiring unit 1 separates the acquired utterances by a predetermined time width or for each series of utterances, assigns a number i to each of the separated utterances so that their chronological order is clear, and stores the utterances i into the utterance storing unit 4 in chronological order. The data format of the utterances may be variable-length character string data or speech data corresponding to the utterances, or may be video data including speech data. For example, the character string data may be a character string recognized from the speech of the utterance, and the speech data may be the utterance speech data itself or the speech data included by the video data. Then, for example, the utterance acquiring unit 1 acquires the first to t−1^{st} past utterances (i=1 to t−1) by the utterer as utterances for creating a tensor to be described later, and acquires a current utterance by the utterer, which corresponds to the t^{th} utterance, as an utterance to be subjected to speech recognition. In addition, the utterance acquiring unit 1 may assign time information, such as utterance start time and utterance end time, to the respective utterances and thereby identify the order of the utterances.

As described above, the utterance acquiring unit 1 acquires character string data, speech data and video data as utterances, and also acquires time information such as the order of the utterances and time-of-date information. The utterances and the time information become situational information that represents a situation at the time of corresponding utterance by the utterer.

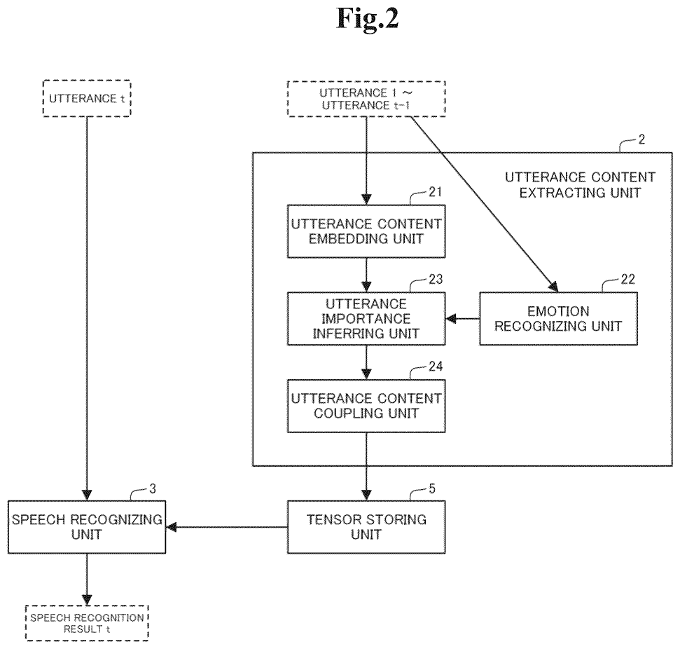

The utterance content extracting unit 2 (transforming unit, weighting unit) has a function for transforming the past utterances (1 to t−1) by the utterer into feature vectors and weighting the feature vector with the importance of the utterance based on a situation at the time of the utterance. In order to realize such a function, the utterance content extracting unit 2 includes, as shown in FIG. 2, an utterance content embedding unit 21, an emotion recognizing unit 22, an utterance importance inferring unit 23, and an utterance content coupling unit 24.

The utterance content embedding unit 21 reads out the past utterances i, namely, the utterances 1 to t−1 stored in the utterance storing unit 4, and performs a process of transforming the variable-length data of each of the utterances i into a fixed-length embedding vector space with the content of the corresponding utterance being reflected. That is to say, the utterance content embedding unit 21 transforms data of each of the utterances i into a feature vector representing a characteristic of the content of the utterance.

The emotion recognizing unit 22 reads out the past utterances i, namely, the utterances 1 to t−1 stored in the utterance storing unit 4, and estimates the emotion of the utterer at the time of the utterance based on the utterance. For example, in a case where the utterance is character string data or speech data, the emotion recognizing unit 22 transforms the data sequence into a feature value, and estimates the emotion from the feature value. Moreover, for example, in a case where the utterance is video data including speech data, the emotion recognizing unit 22 transforms the facial expression, gesture or the like of the utterer into a feature value, and estimates the emotion from the feature value. At this time, the emotion recognizing unit 22 previously sets, for each feature value, an emotion label representing the type of emotion and the intensity of the emotion corresponding to each emotion label, and estimates an emotion label and the intensity of emotion corresponding to the transformed feature value. However, the emotion estimation by the emotion recognizing unit 22 may be performed in any method. For example, a machine learning model showing the relation between the stored utterances and their emotion labels and intensities may be generated, and the estimation may be performed using the model.

For example, labels such as calmness, anger, sadness, fun, and excitement are prepared as the types of emotions. However, as the types of the emotion labels, those other than described above can also be used. When estimating an emotion corresponding to each emotion, the emotion recognizing unit 22 outputs a label thereof. Moreover, in the case of outputting the magnitude of the emotion label, the emotion recognizing unit 22 first estimates an emotion label corresponding to an utterance as described above, and estimates the magnitude of the emotion in accordance with how much each emotion is included in the utterance. The magnitudes of emotions to be estimated may be expressed in the form of absolute values, and may be expressed as the probability distribution of the respective emotions. However, since the emotion label and the magnitude of the emotion label inferred by the emotion recognizing unit 22 are used as input for the utterance importance inferring unit 23, it is favorable to define the relation between the two in a consistent manner.

In the following description, two types of emotion labels, “calmness” and “others”, will be used, and the result of estimation of emotion will follow the probability distribution. That is to say, the sum of the magnitudes of the emotions, “calmness” and “others” is designed to be “1”.

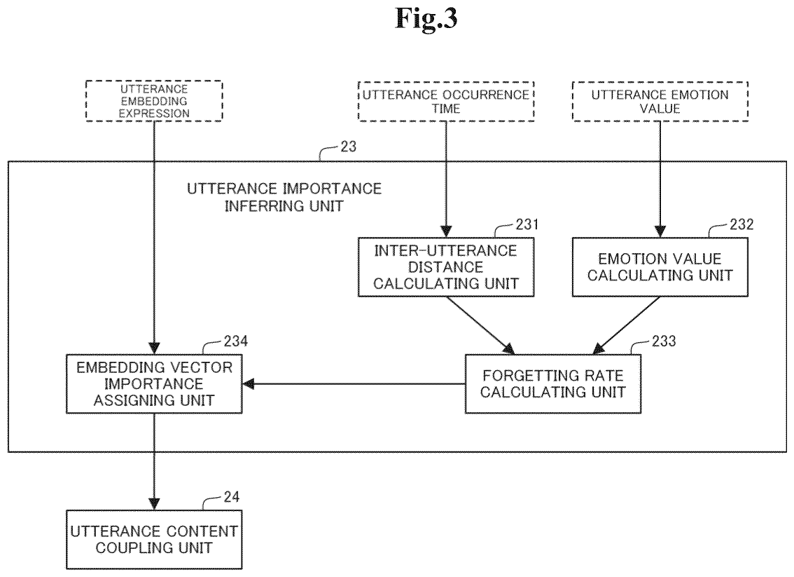

The utterance importance inferring unit 23 calculates the importance of each utterance based on the emotion of the utterance estimated by the emotion recognizing unit 22 described above, and weights an embedding vector corresponding to the utterance with the importance. In this example embodiment, the utterance importance inferring unit 23 further calculates the importance of the utterance based on not only the emotion at the time of the utterance but also time information of the utterance. Then, the utterance importance inferring unit 23 includes an inter-utterance distance calculating unit 231, an emotion value calculating unit 232, a forgetting rate calculating unit 233, and an embedding vector importance assigning unit 234 as shown in FIG. 3 in order to realize the calculation of the importance of the utterance and the weighting of the embedding vector corresponding to the utterance with the importance.

The inter-utterance distance calculating unit 231 calculates, for each past utterance i, an elapsed time from the occurrence time of the utterance i to the current time that is the occurrence time of the current utterance t to be subjected to recognition, or an amount corresponding to the elapsed time, and sets it as an inter-utterance distance δ. For example, in a case where the start times of the utterance i and the utterance t are stored, respectively, the inter-utterance distance calculating unit 231 calculates the inter-utterance distance δ by taking the difference between these two times. Moreover, the inter-utterance distance calculating unit 231 may calculate the inter-utterance distance δ by another calculation method. For example, the inter-utterance distance calculating unit 231 may use the order i of utterance as the amount corresponding to the time and calculate the inter-utterance distance δᵢ=t−i. In the following description, the inter-utterance distance δᵢ using the order of utterance will be calculated. Thus, the value of the inter-utterance distance δᵢ is calculated larger as an utterance is more previous and, as will be described later, the importance of the utterance is calculated smaller as the inter-utterance distance δᵢ is larger.

The emotion value calculating unit 232 calculates, as the emotion value of the utterance I, the mean value of emotions before and after the emotion value of the utterance i. That is to say, it can be understood that, with the utterance i as the starting point, as a response to an utterance prior to the utterance i and to an emotion included by the utterance, the utterance i and an accompanying emotion appeared. On the other hand, an emotional response included by an utterance later than the utterance i is considered as a response to the utterance i. In consideration of the above, the emotion value calculating unit 232 calculates the respective emotion labels of the utterances before and after the speech i, or the mean value of the magnitudes of the respective emotion labels. The averaging process includes not only simple arithmetic average but also a method using unique weighting and a method of inference using only the utterance i. Moreover, the range of the averaging process is adjusted automatically or manually as necessary. Furthermore, the averaging process also includes a method of adjusting the weight in accordance with the type and magnitude of the emotion label.

In this example embodiment, focusing on a response of a conversation to the utterance i, backward average is taken. Moreover, in this example embodiment, an emotion label is defined by two types of labels, “calmness” and “others”, as described above. Therefore, the average of the magnitudes of “others” labels inferred to have swayed from “calmness” is calculated as the emotion value. The average of the magnitudes of k+1 “others” labels including the utterance i is taken all with equal weight. Therefore, the emotion value of the “others” labels is calculated by Formula 1 below.

$$< {E}_{i} > = ( \sum {}_{j = i}^{i + k} {E}_{j} ) / ( k + 1 ) \qquad [ Formula 1 ]$$

Here, in this example embodiment, according to the definition of the emotion recognizing unit 22, <Eᵢ>≤1 is satisfied. Moreover, the definition is that, in a case where the past utterance i is close to the current utterance i, specifically, when the utterance i satisfies i+k>t, <Eᵢ>=1 is satisfied. That is to say, an utterance immediately before the utterance t is set to be considered with weight 1 without weighting. However, the weighting of the utterance i immediately before the utterance t may be another definition.

The forgetting rate calculating unit 233 calculates the importance of utterance for the utterance i based on the inter-utterance distance δ obtained from the inter-utterance distance calculating unit 231 and the emotion value obtained from the emotion value calculating unit 232. Here, the importance is a weight on each utterance i, and the forgetting rate calculating unit 233 calculates the importance based on the elapsed time and the emotion value. The forgetting rate calculating unit 233 calculates the importance so that it decreases as the inter-utterance distance δ is larger, in order to lower the degree of attention to an utterance after a certain forgetting time.

Further, an utterance distance constant τᵢ corresponding to a forgetting time is set for each emotion label. In this example embodiment, only the utterance distance constant τᵢ of the “others” label is set. In accordance with the mean value of the “others” label, an important statement effective time Tᵢ is changed by Tᵢ=<Eᵢ>×τᵢ. Here, from the definition of the mean value of the “others” label, Tᵢ≤τᵢ holds, and a more important utterance gets closer to the utterance distance constant tᵢ. The importance Iᵢ of the utterance i is calculated using the important statement effective time Tᵢ by Formula 2. As shown in this formula, the larger a predetermined emotion value, namely, the magnitude of the “others” label, the greater the importance.

$${I}_{i} = {2}^{- {δ}_{i} / {T}_{i}} \qquad [ Formula 2 ]$$

In addition, the above example shows a case of calculating the importance of the utterance i based on the emotion value and the inter-utterance distance, but it may be calculated based on the emotion value alone, independent of the inter-utterance distance.

The embedding vector importance assigning unit 234 performs a weighting process on an embedding expression of the utterance i obtained from the utterance content embedding unit 21 as described above with the importance of the utterance i obtained from the forgetting rate calculating unit 233. The embedding vector importance assigning unit 234 can be realized by, for example, multiplying the embedding expression of the utterance i by the value of the importance. That is to say, the smaller the value of the importance, the smaller the weight of the embedding vector corresponding to the utterance i.

In this example embodiment, the embedding vector importance assigning unit 234 calculates an importance assigned embedding vector Vi using an embedding expression Ui of the utterance i obtained from the utterance content embedding unit 21 and the importance Iᵢ of the utterance i described above by Formula 3.

$${V}_{i} = {I}_{i} {U}_{i} \qquad [ Formula 3 ]$$

In addition, in a case where it falls below predetermined importance, a process of erasing the embedding vector may be added. However, the weighting process by the embedding vector importance assigning unit 234 is not limited to the process described above, and another method may be used.

The utterance importance inferring unit 23 executes the processing described above on all the embedding vectors, and outputs all the importance assigned embedding vectors to the utterance content coupling unit 24.

The utterance content coupling unit 24 performs a process of coupling the embedding vectors each weighted with importance by the utterance importance inferring unit 23 and transforming into one tensor. Then, the utterance content coupling unit 24 stores the generated tensor in the tensor storing unit 5.

The speech recognizing unit 3 reads out an utterance t to be subjected to speech recognition acquired by the utterance acquiring unit 1 and stored in the utterance storing unit 4, and also reads out the tensor generated as described above from the tensor storing unit 5. Then, the speech recognizing unit 3 performs a speech recognition process on the utterance t using the tensor. For example, the speech recognizing unit 3 transforms the utterance t into an embedding vector, extracts a corresponding embedding vector from the tensor, and performs speech recognition based on the extracted embedding vector. Then, the speech recognizing unit 3 outputs a speech recognition result t on the utterance t.

### [Operation]

Next, the operation of the above speech recognition apparatus 10 will be described with reference to the flowchart shown in FIG. 4. First, the speech recognition apparatus 10 acquires past utterances, and transforms the utterances 1 to t−1 into embedding vectors, respectively (step S1). Subsequently, the speech recognition apparatus 10 estimates, for each of the utterances 1 to t−1, an inter-utterance distance from the current and an emotion value (step S2). Subsequently, the speech recognition apparatus 10 estimates, for each of the utterances 1 to t−1, importance based on the estimated inter-utterance distance and emotion value, and transforms into an embedding vector with the importance added to the embedding vector (step S3). Then, the speech recognition apparatus 10 couples the respective embedding vectors of the utterances 1 to t−1 to transform into one embedded tensor and stores the tensor (step S4). After that, the speech recognition apparatus acquires an utterance t to be newly subjected to speech recognition, performs speech recognition using the embedded tensor, and outputs a speech recognition result t (step S5).

In addition, a method of processing all the past utterances 1 to t−1 in bulk at steps S1 to S3 and then coupling into one tensor at step S4 is disclosed in the above, but the utterances may be processed one by one at steps S1 to S3 and thereafter coupled into one tensor at step S4.

As described above, according to this example embodiment, it is possible to generate an embedding vector representing the feature of an utterance with the importance of the utterance assigned, corresponding to a situation at the time of the utterance by the utterer, such as the time of the utterance and the emotion of the utterer. Since speech recognition is performed in consideration of important past information by performing speech recognition using the embedding vector with the importance assigned, it is possible to increase the accuracy of speech recognition.

### Second Example Embodiment

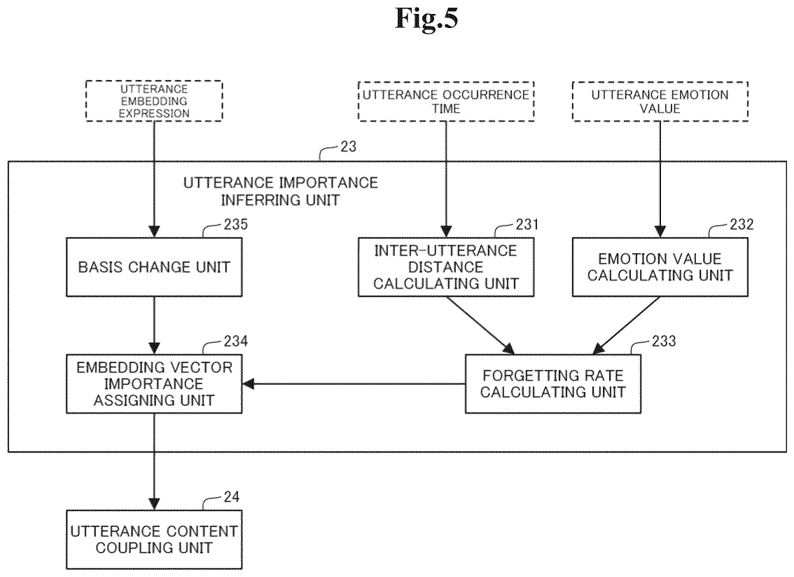

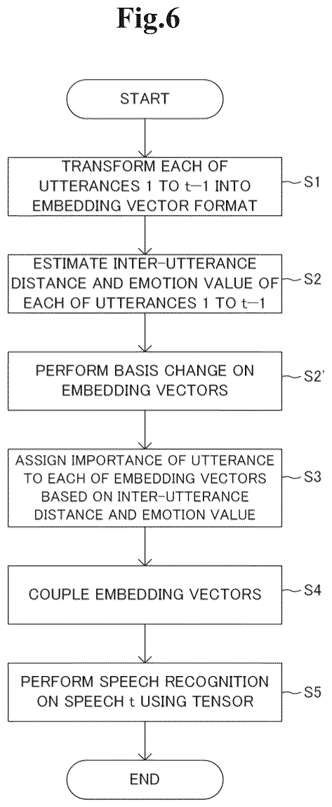

Next, a second example embodiment of the present disclosure will be described with reference to FIGS. 5 and 6. FIG. 5 is a diagram for describing the configuration of a speech recognition apparatus, and FIG. 6 is a diagram for describing the processing operation of the speech recognition apparatus.

### [Configuration]

In the speech recognition apparatus 10 in this example embodiment, in addition to the configuration in the first example embodiment described above, the utterance importance inferring unit 23 further includes a basis change unit 235 as shown in FIG. 5. Below, a configuration different from that of the first example embodiment will be described mainly.

The basis change unit 235 performs basis change on the embedding expression of the utterance i by eigenvalue decomposition, for example. The basis used for eigenvalue decomposition is prepared before the basis change unit 235 is operated. For example, a statistically sufficient number of conversation character strings are prepared, and embedding vectors thereof are generated. A basis vector obtained by principal component analysis of the components of the embedding vector is used as the basis of the basis change unit 235. By sorting the embedding vectors having been subjected to eigenvalue decomposition in order from a basis corresponding to a general content common in the prepared conversation character strings described above, that is, a basis with larger norm, to a basis corresponding to a special content appearing only in individual conversations, that is, a basis with smaller norm, it is possible to determine the ratio of the generality and specialty of the contents of the utterances from the magnitudes of the components. Thus, by sorting in order from an important basis, that is, a basis with larger norm, it is possible to sort in order from important information. In addition, for the implementation of the basis change unit 235, a method other than eigenvalue decomposition may be used as long as the method enables extraction of statistically important information.

Then, the basis change unit 235 outputs the embedding vectors having been subjected to basis change to the embedding vector importance assigning unit 234. The embedding vector importance assigning unit 234 efficiently selects the importance by leaving more components of the embedding vector of an utterance with higher importance and leaving less components of the embedding vector of an utterance with lower importance. There is a plurality of ways to leave the components of each basis in correspondence with the importance. To be specific, since the importance Iᵢ of a conversation takes a value equal to or more than 0 and equal to or less than 1, this is regarded as a ratio, and the number of components of a vector with the same ratio is left. For example, in the case of Iᵢ=0.75, 75% of the total components are stored from a component corresponding to a basis with larger norm to a component corresponding to a basis with smaller norm described above. As another example, also in the case of importance Iᵢ=0.75, 75% of the components of a vector are left from a component with a larger absolute value and the bottom 25% are set to 0. The former evaluates each utterance based on the generality of the topic and reduces the dimension, whereas the latter leaves components when they are large even if they are specific to conversation content, thereby reducing the dimension more in line with the conversation content.

### [Operation]

Next, the operation of the above speech recognition apparatus 10 will be described with reference to the flowchart shown in FIG. 6. In this example embodiment, steps S1 to S5 are almost the same as in the first example embodiment, and step S2′ is added between steps S2 and S3.

First, the speech recognition apparatus 10 transforms the utterances 1 to t−1 into embedding vectors, respectively (step S1), and estimates inter-utterance distances and emotion values, respectively (step S2). Subsequently, the speech recognition apparatus 10 performs basis change of an embedded expression of an utterance i by eigenvalue decomposition (step S2′). By thus performing the basis change, it is possible to sort the components of the embedding vectors in order from the important basis. Subsequently, the speech recognition apparatus 10 estimates, for each utterance, importance based on the estimated inter-utterance distance and emotion value in the same manner as described above, adds the importance to the embedding vector, and transforms the utterance into the embedding vector (step S3). At this time, the speech recognition apparatus 10 can also perform dimensional compression by adjusting the number of the components of the embedding vector, for example, by leaving more components in the case of important information. Then, the speech recognition apparatus 10 couples the embedding vectors into one embedding tensor (step S4). After that, the speech recognition apparatus 10 acquires an utterance t to be newly subjected to speech recognition, performs speech recognition using the embedded tensor, and outputs a speech recognition result t (step S5).

As described above, according to this example embodiment, it is possible to further extract important information during utterance compared to the first example embodiment. Therefore, it is possible to focus on important information during utterance with higher accuracy. Moreover, at the time of performing dimensional compression, it is possible to erase the components of each vector in a predetermined order in accordance with the emotion value, and store only the number of remaining components and the values of the respective components, thereby saving memory.

### Third Example Embodiment

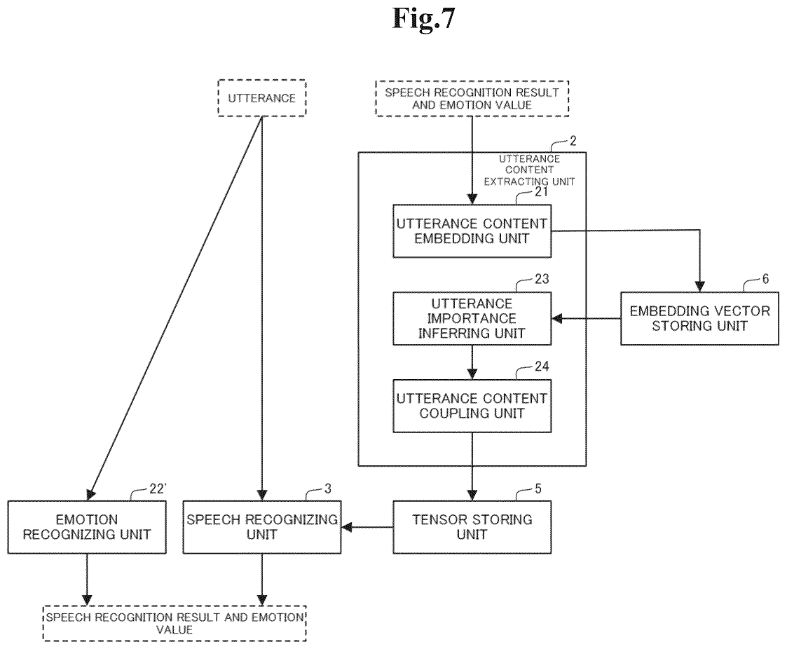

Next, a third example embodiment of the present disclosure will be described with reference to FIG. 7. FIG. 7 is a diagram for describing the configuration of a speech recognition apparatus.

The speech recognition apparatus 10 in this example embodiment includes, as shown in FIG. 7, an emotion recognizing unit 22′ outside the utterance content extracting unit 2 in comparison to the configuration in the first example embodiment described above, and is configured to recognize the emotion of an utterance every time the utterance occurs. Therefore, for example, when utterances such as utterances 1 to t−1 arise, speech recognition by the speech recognition unit 3 and emotion estimation by the emotion recognizing unit 22′ are performed at all times. Then, the speech recognition result and the emotion value of each utterance are input to the utterance importance inferring unit 23.

Further, as shown in FIG. 7, the speech recognition apparatus 10 in this example embodiment includes an embedding vector storing unit 6 in the utterance importance inferring unit 23. Then, the utterance content embedding unit 21 in the utterance importance inferring unit 23 in this example embodiment creates an embedding vector of each utterance in the same manner as described above, and stores it into the embedding vector storing unit 6. At this time, the utterance content embedding unit 21 stores the speech recognition result and the emotion value of each utterance in association. Consequently, for example, every time the utterances 1 to t−1 arise, the speech recognition apparatus 10 generates the speech recognition result and the emotion value described above and generates an embedding vector and stores it into the embedding vector storing unit 6.

Then, for every lapse of time, the utterance importance inferring unit 23 in this example embodiment calculates the importance of the embedding vector corresponding to each of the utterances 1 to t−1 stored in the embedding vector storing unit 6 based on the emotion value stored in the embedding vector storing unit 6 and time information of each utterance in the same manner as described above, and weights each embedding vector. This is because the importance of utterance changes over time. Then, the utterance content coupling unit 24 couples and tensorizes the weighted embedding vectors. In addition, the weighting and the coupling of the embedding vectors by the utterance importance inferring unit 23 and the utterance content coupling unit 24 may be performed at certain time intervals or at preset timings, and may be performed at the timing when the utterance t subjected to recognition arises.

Then, upon acquiring an utterance t to be newly subjected to speech recognition, the speech recognizing unit 3 executes speech recognition using the latest tensor generated over time as described above, and outputs a speech recognition result t.

As described above, according to this example embodiment, speech recognition can be performed using a tensor with appropriate importance assigned over time, and the accuracy of speech recognition can be further increased.

### Fourth Example Embodiment

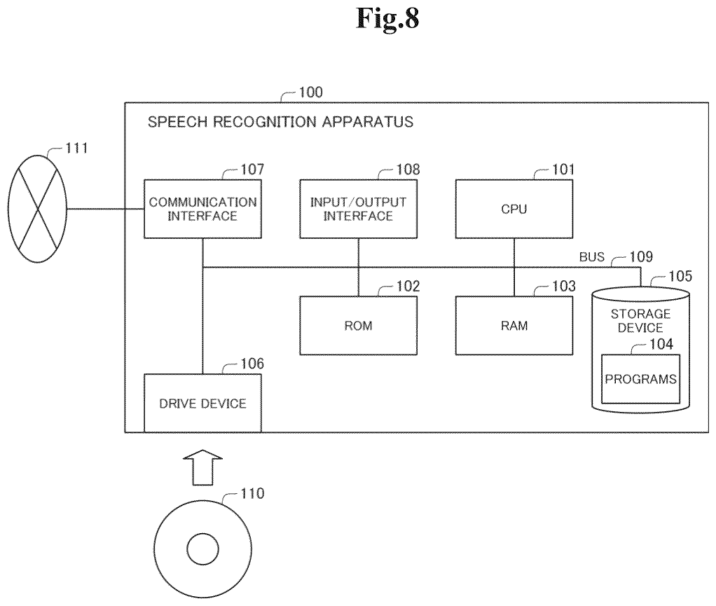

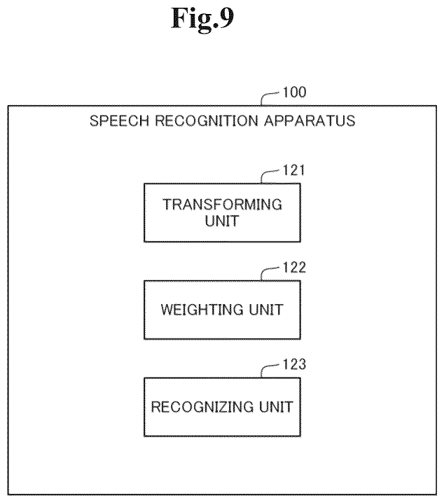

Next, a fourth example embodiment of the present disclosure will be described with reference to FIGS. 8 and 9. FIGS. 8 and 9 are block diagrams showing the configuration of a speech recognition apparatus in the fourth example embodiment. In this example embodiment, the overview of the configuration of the speech recognition apparatus described in the above example embodiments will be shown.

First, the hardware configuration of the speech recognition apparatus 100 in this example embodiment will be described with reference to FIG. 8. The speech recognition apparatus 100 is configured with a general information processing apparatus and, as an example, has a hardware configuration as described below including:
a CPU (Central Processing Unit) 101 (arithmetic logic unit);
a ROM (Read Only Memory) 102 (memory unit);
a RAM (Random Access Memory) 103 (memory unit);
programs 104 loaded to the RAM 103;
a storage device 105 storing the programs 104;
a drive device 106 reading from and writing into a storage medium 110 outside the information processing apparatus;
a communication interface 107 connected to a communication network 111 outside the information processing apparatus;
an input/output interface 108 performing input/output of data; and
a bus 109 connecting the components.

FIG. 8 shows an example of the hardware configuration of the information processing apparatus serving as the speech recognition apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller or a combination of these, instead of the abovementioned CPU.

Then, the speech recognition apparatus 100 can construct and include a transforming unit 121, a weighting unit 122, and a recognizing unit 123 shown in FIG. 9 by the CPU 101 acquiring and executing the programs 104. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the transforming unit 121, the weighting unit 122 and the recognizing unit 123 described above may be constructed using dedicated electronic circuits for realizing such means.

The transforming unit 121 transforms an utterance by an utterer into a feature vector. For example, the transforming unit 121 performs a process of transforming variable-length data of each utterance into a fixed-length embedding vector space with the content of the corresponding utterance being reflected.

The weighting unit 122 weights the feature vector with importance of the utterance based on situation information representing a situation at the time of the utterance of the utterer. At this time, the situation information is, for example, the emotion of the utterer and time information of the utterance. For example, the weighting unit 122 estimates an emotion of the utterer from the feature value of the utterance, and the like. Then, the weighting unit 122 calculates the importance of the utterance based on the emotion and the time information, and assigns the importance to the feature vector of the utterance.

The recognizing unit 123 recognizes a new utterance by the utterer based on the weighted feature vector.

With the configuration as described above, the present disclosure enables generation of a feature vector representing a feature of an utterance with importance of each utterance assigned corresponding to a situation at the time of each utterance by an utterer, such as a time of the utterance and the emotion of the utterer. Then, by performing speech recognition using the feature vector with the importance assigned, speech recognition is performed in consideration of the important past information, so that it is possible to increase the accuracy of speech recognition.

The abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic wave. The temporary computer-readable medium may provide a program to the computer via a wired communication channel, such as an electric wire and an optical fiber, or a wireless communication channel.

Although the present disclosure has been described above with reference to the above-described example embodiments, the present disclosure is not limited to the embodiments described above. The configuration and details of the present disclosure can be changed in a variety of ways that those skilled in the art can understand within the scope of the present disclosure. In addition, at least one or more functions of the transforming unit 121, the weighting unit 122 and the recognizing unit 123 may be performed by the information processing apparatus installed and connected anywhere on the network, that is, may be performed by so-called cloud computing.

### <Supplementary Notes>

The whole or part of the example embodiments disclosed above can be described as the following supplementary notes. Below, the overview of the configurations of a speech recognition method, a speech recognition apparatus, and a program will be described. However, the present disclosure is not limited to the following configurations.

### (Supplementary Note 1)

A speech recognition apparatus comprising:
a transforming unit that transforms an utterance by an utterer into a feature vector;
a weighting unit that weights the feature vector with importance of the utterance based on situation information representing a situation at time of the utterance by the utterer; and
a recognizing unit that recognizes a new utterance by the utterer based on the weighted feature vector.

### (Supplementary Note 2)

The speech recognition apparatus according to supplementary note 1, wherein the weighting unit estimates an emotion at the time of the utterance of the utterer based on the situation information, calculates the importance of the utterance based on the emotion, and weights the feature vector with the importance.

### (Supplementary Note 3)

The speech recognition apparatus according to supplementary note 2, wherein the weighting unit estimates the emotion of the utterer from speech or video of the utterer that is the situation information, calculates the importance of the utterance based on the emotion, and weights the feature vector with the importance.

### (Supplementary Note 4)

The speech recognition apparatus according to supplementary note 2 or 3, wherein the weighting unit calculates the importance so that the importance is larger as a degree of a preset emotion at the time of the utterance of the utterer is larger.

### (Supplementary Note 5)

The speech recognition apparatus according to any of supplementary notes 2 to 4, wherein the weighting unit calculates the importance of speech based on time information at the time of the utterance by the utterer that is the situation information, and weights the feature vector with the importance.

### (Supplementary Note 6)

The speech recognition apparatus according to supplementary note 5, wherein the weighting unit calculates the importance so that the importance is smaller as time is more previous based on the time information at the time of the utterance by the utterer.

### (Supplementary Note 7)

The speech recognition apparatus according to supplementary note 5 or 6, wherein the weighting unit calculates the importance of the utterance based on the time information for each lapse of time, and weights the feature vector with the importance.

### (Supplementary Note 8)

The speech recognition apparatus according to any of supplementary notes 1 to 7, wherein the transforming unit transforms the utterance by the utterer into the feature vector based on a preset basis.

### (Supplementary Note 9)

A speech recognition method comprising:
transforming an utterance by an utterer into a feature vector;
weighting the feature vector with importance of the utterance based on situation information representing a situation at time of the utterance by the utterer; and
recognizing a new utterance by the utterer based on the weighted feature vector.

### (Supplementary Note 10)

The speech recognition method according to supplementary note 9, comprising estimating an emotion at the time of the utterance of the utterer based on the situation information, calculating the importance of the utterance based on the emotion, and weighting the feature vector with the importance.

### (Supplementary Note 11)

The speech recognition method according to supplementary note 10, comprising estimating the emotion of the utterer from speech or video of the utterer that is the situation information, calculating the importance of the utterance based on the emotion, and weighting the feature vector with the importance.

### (Supplementary Note 12)

The speech recognition method according to supplementary note 10 or 11, comprising calculating the importance so that the importance is larger as a degree of a preset emotion at the time of the utterance of the utterer is larger.

### (Supplementary Note 13)

The speech recognition method according to any of supplementary notes 10 to 12, comprising calculating the importance of speech based on time information at the time of the utterance by the utterer that is the situation information, and weighting the feature vector with the importance.

### (Supplementary Note 14)

The speech recognition method according to supplementary note 13, comprising calculating the importance so that the importance is smaller as time is more previous based on the time information at the time of the utterance by the utterer.

### (Supplementary Note 15)

The speech recognition method according to supplementary note 13 or 14, comprising calculating the importance of the utterance based on the time information for each lapse of time, and weighting the feature vector with the importance.

### (Supplementary Note 16)

The speech recognition method according to any of supplementary notes 9 to 15, comprising transforming the utterance by the utterer into the feature vector based on a preset basis.

### (Supplementary Note 17)

A non-transitory computer-readable storage medium storing a program, the program comprising instructions for causing a computer to execute processes to:
transform an utterance by an utterer into a feature vector;
weight the feature vector with importance of the utterance based on situation information representing a situation at time of the utterance by the utterer; and
recognize a new utterance by the utterer based on the weighted feature vector.

The present invention is based upon and claims the benefit of priority from Japanese patent application No. 2022-112878, filed on Jul. 14, 2022, the disclosure of which is incorporated herein in its entirety by reference.

### REFERENCE SIGNS LIST

1 utterance acquiring unit
2 utterance content extracting unit
3 speech recognizing unit
4 utterance storing unit
tensor storing unit
6. embedding vector storing unit
speech recognition apparatus
21 utterance content embedding unit
22 emotion recognizing unit
23 utterance importance inferring unit
24 utterance content coupling unit
231 inter-utterance distance calculating unit
232 emotion value calculating unit
233 forgetting rate calculating unit
234 embedding vector importance assigning unit
235 basis change unit
100 speech recognition apparatus
101 CPU
102 ROM
103 RAM
104 programs
105 storage device
106 drive device
107 communication interface
108 input/output interface
109 bus
110 storage medium
111 communication network
121 transforming unit
122 weighting unit
123 recognizing unit

What is claimed is:

1. A speech recognition apparatus comprising:
at least one memory storing processing instructions; and
at least one processor configured to execute the processing instructions to:
transform an utterance by an utterer into a feature vector;
weight the feature vector with importance of the utterance based on situation information representing a situation at time of the utterance by the utterer; and
recognize a new utterance by the utterer based on the weighted feature vector.

2. The speech recognition apparatus according to claim 1, wherein the at least one processor is configured to execute the processing instructions to
estimate an emotion at the time of the utterance of the utterer based on the situation information, calculate the importance of the utterance based on the emotion, and weight the feature vector with the importance.

3. The speech recognition apparatus according to claim 2, wherein the at least one processor is configured to execute the processing instructions to
estimate the emotion of the utterer from speech or video of the utterer that is the situation information, calculate the importance of the utterance based on the emotion, and weight the feature vector with the importance.

4. The speech recognition apparatus according to claim 2, wherein the at least one processor is configured to execute the processing instructions to
calculate the importance so that the importance is larger as a degree of a preset emotion at the time of the utterance of the utterer is larger.

5. The speech recognition apparatus according to claim 2, wherein the at least one processor is configured to execute the processing instructions to
calculate the importance of speech based on time information at the time of the utterance by the utterer that is the situation information, and weight the feature vector with the importance.

6. The speech recognition apparatus according to claim 5, wherein the at least one processor is configured to execute the processing instructions to
calculate the importance so that the importance is smaller as time is more previous based on the time information at the time of the utterance by the utterer.

7. The speech recognition apparatus according to claim 5, wherein the at least one processor is configured to execute the processing instructions to
calculate the importance of the utterance based on the time information for each lapse of time, and weight the feature vector with the importance.

8. The speech recognition apparatus according to claim 1, wherein the at least one processor is configured to execute the processing instructions to
transform the utterance by the utterer into the feature vector based on a preset basis.

9. A speech recognition method comprising:
transforming an utterance by an utterer into a feature vector;
weighting the feature vector with importance of the utterance based on situation information representing a situation at time of the utterance by the utterer; and
recognizing a new utterance by the utterer based on the weighted feature vector.

10. The speech recognition method according to claim 9, comprising
estimating an emotion at the time of the utterance of the utterer based on the situation information, calculating the importance of the utterance based on the emotion, and weighting the feature vector with the importance.

11. The speech recognition method according to claim 10, comprising
estimating the emotion of the utterer from speech or video of the utterer that is the situation information, calculating the importance of the utterance based on the emotion, and weighting the feature vector with the importance.

12. The speech recognition method according to claim 10, comprising
calculating the importance so that the importance is larger as a degree of a preset emotion at the time of the utterance of the utterer is larger.

13. The speech recognition method according to claim 10, comprising
calculating the importance of speech based on time information at the time of the utterance by the utterer that is the situation information, and weighting the feature vector with the importance.

14. The speech recognition method according to claim 13, comprising
calculating the importance so that the importance is smaller as time is more previous based on the time information at the time of the utterance by the utterer.

15. The speech recognition method according to claim 13, comprising
calculating the importance of the utterance based on the time information for each lapse of time, and weighting the feature vector with the importance.

16. The speech recognition method according to claim 9, comprising
transforming the utterance by the utterer into the feature vector based on a preset basis.

17. A non-transitory computer-readable storage medium storing a program, the program comprising instructions for causing a computer to execute processes to:
transform an utterance by an utterer into a feature vector;
weight the feature vector with importance of the utterance based on situation information representing a situation at time of the utterance by the utterer; and
recognize a new utterance by the utterer based on the weighted feature vector.
